(19) United States
(12) Patent Application Publication
(10) Pub. No.: US 2013/0250195 A1
(43) Pub. Date: Sep. 26, 2013

(54) DISPLAY DEVICE AND ELECTRONIC DEVICE

(71) Applicant: JAPAN DISPLAY WEST, INC., Aichi-Ken (JP)

(72) Inventors: Takeo Koito, Kanagawa (JP); Daisuke Takama, Kanagawa (JP)

(73) Assignee: JAPAN DISPLAY WEST, INC., Aichi-Ken (JP)

(21) Appl. No.: 13/780,724

(22) Filed: Feb. 28, 2013

(30) Foreign Application Priority Data
Mar. 23, 2012 (JP) 2012-067938

(51) Int. Cl. G02F 1/13

(52) U.S. Cl. CPC G02F 1/1313
USPC 349/15

(57) ABSTRACT

A display device which includes a display unit having a plurality of pixels and an optical device, in which the optical device is provided with a first substrate, a second substrate, and a structure for securing a predetermined gap between the first substrate and the second substrate, the pixels are configured by a plurality of sub-pixels of which colors are different, and are aligned in a first direction, and a gap at which the structure is arranged in the first direction is different from a gap at which the pixels are arranged.

### BACKGROUND

The present technology relates to a display device, and an electronic device. Specifically, the present technology relates to a display device, and an electronic device which is able to supply a two-dimensional image, and a three-dimensional image in a switching manner, and does not cause image deterioration such as coloring or the like.

Since it is possible to produce a thin liquid crystal display device, the device is widely spread in various fields. In the liquid crystal display device, a color filter substrate on which a color filter or the like is formed at a location corresponding to a pixel electrode faces a TFT substrate on which the pixel electrode, a thin film transistor (TFT), and the like are formed in a matrix, and liquid crystal is interposed between the TFT substrate and the color filter substrate. In addition, an image is formed by controlling the transmittance of light due to the liquid crystal material in each pixel.

Data lines which are extended in the vertical direction, and are arranged in the horizontal direction, and scanning lines which are extended in the horizontal direction, and are arranged in the vertical direction are present on the TFT substrate, and pixels are formed in a region which is surrounded with the data lines and the scanning lines. The pixels are mainly configured by pixel electrodes, and thin film transistors (TFT) as switching elements. A display region is formed by many pixels which are formed in a matrix in this manner.

A liquid crystal lens in which a liquid crystal layer plays the role of a lens using the properties of a liquid crystal material has also been proposed (for example, refer to Japanese Unexamined Patent Application Publication Nos. 2008-9370, 2007-226231, and 2008-83366). That is, the lens controls the path of incident light in each position using a difference in refractive index between a material configuring the lens and air, however, when applying voltages which are different from each other by position to the liquid crystal layer, and driving the liquid crystal layer using electric fields which are different from each other by position, the incident light which is input to the liquid crystal layer has phase changes which are different from each other by position, and as a result, the liquid crystal layer is able to control the path of the incident light like a lens.

By arranging such a liquid crystal lens on a display area in which the above described liquid crystal is inserted, realization of stereoscopic vision in which dedicated glasses are not necessary is proposed.

In addition, in an optical device having a liquid crystal layer such as a liquid crystal lens or a display device, in order to maintain a gap in the liquid crystal layer, a spacer which is formed of silica gel, or resin is used (for example, refer to Japanese Unexamined Patent Application Publication No. 2011-154197).

### SUMMARY

As described above, a naked-eye stereoscopic display device is configured by laminating an optical element on a display device. In addition, when liquid crystal is used in a display device or an optical element, a spacer is provided so that the thickness of the liquid crystal layer is controlled.

However, since the thickness of the liquid crystal layer which is necessary for the liquid crystal lens or the like is generally 20 μm or more, when a dispersed spacer is used as a spacer, there has been crosstalk or a case in which a display property in a two-dimensional image is affected. In addition, when the position of the spacer is controlled using lithography and a columnar spacer is used, there have been cases in which display is colored, and image quality is deteriorated due to a positional relationship between pixels of the display device and the spacer of the optical element.

It is desirable to locate a spacer of an optical element at a position not accompanied by deterioration of image quality.

According to an embodiment of the present technology, there is provided a display device which includes a display unit having a plurality of pixels, and an optical device, in which the optical device is provided with a first substrate, a second substrate, and a structure for securing a predetermined gap between the first substrate and the second substrate, the pixels are configured by a plurality of sub-pixels of which colors are different, and are aligned in a first direction, and a gap at which the structure is arranged in the first direction is different from a gap at which the pixels are arranged.

The structure may be created at a position corresponding to a black matrix in the display unit.

The structure may be arranged by being scattered in the vicinity of the sub-pixels of different colors in at least one direction of a vertical direction and a horizontal direction.

The structure which is neighboring in the vertical direction or the horizontal direction may be arranged by being deviated in the neighboring direction.

The structure which is neighboring in the vertical direction or the horizontal direction may be arranged at a position which is separated by a predetermined number of sub-pixels in the neighboring direction.

The structure which is neighboring in the vertical direction or the horizontal direction may be arranged at a position which is separated by a predetermined multiple based on a gap between the pixels in the neighboring direction.

The structure which is neighboring in the vertical direction or the horizontal direction may be arranged at a position which is separated by a generated random number based on the gap between the pixels in the neighboring direction.

The structure may be arranged at a center portion of a lens unit which selectively changes a passage state of rays from the display unit.

The sub-pixel may be arranged so that a position where the neighboring structure is arranged becomes a sub-pixel of which the color is different.

According to another embodiment of the present technology, there is provided an electronic device which includes a display unit having a plurality of pixels and an optical device, in which the optical device is provided with a first substrate, a second substrate, and a structure for securing a predetermined gap between the first substrate and the second substrate, the pixels are configured by a plurality of sub-pixels of which colors are different, and are aligned in a first direction, and a gap at which the structure is arranged in the first direction is different from a gap at which the pixels are arranged.

According to embodiments of the present technology, there is provided a display device and an electronic device which are configured by a display unit having a plurality of pixels and an optical device. The optical device is provided with a first substrate, a second substrate, and a structure for securing a predetermined gap between the first substrate and the second substrate, the pixels are configured by a plurality of sub-pixels of which colors are different, and are aligned in a first direction, and a gap at which the structure is arranged in the first direction is configured differently from a gap at which the pixels are arranged.

According to embodiments of the present technology, a spacer of an optical element may be provided at a position in which an image quality is not deteriorated.

### BRIEF DESCRIPTION OF THE DRAWINGS

FIG. 1 is a diagram which illustrates a configuration of a display device including a liquid crystal lens panel;

FIG. 2 is a diagram which illustrates a configuration of the liquid crystal lens panel;

FIG. 3 is a diagram which describes an influence which is caused by a spacer;

FIGS. 4A to 4C are diagrams which describe an arrangement of pixels and the spacers;

FIGS. 5A and 5B are diagrams which describe the arrangement of pixels and the spacers;

FIGS. 6A to 6C are diagrams which describe the arrangement of pixels and the spacers;

FIGS. 7A and 7B are diagrams which describe the arrangement of pixels and the spacers;

FIG. 8 is a diagram which describes the arrangement of pixels and the spacer;

FIG. 9 is a diagram which describes the arrangement of pixels and the spacers;

FIG. 10 is a diagram which describes the arrangement of pixels and the spacers;

FIGS. 11A and 11B are diagrams which describe the arrangement of pixels and the spacers;

FIG. 12A and 12B are diagrams which describe the arrangement of pixels and the spacers;

FIGS. 13A and 13B are diagrams which describe the arrangement of pixels and the spacers; and

FIG. 14 is a diagram which describes the display device.

### DETAILED DESCRIPTION OF EMBODIMENTS

Hereinafter, embodiments of the present technology will be described with reference to drawings.

### Regarding Configuration of Liquid Crystal Lens

Since the present technology which will be described below can be applied to a liquid crystal lens, here, the liquid crystal lens is exemplified, and the present technology will be described. First, descriptions regarding the liquid crystal lens will be added. The liquid crystal lens is used when realizing a stereoscopic vision, for example, by causing a parallax image, in which parallax between the left and right eyes of an observer is caused to occur, to be viewed without dedicated glasses.

A method of not using the dedicated glasses is assumed to be applied to a display of a portable electronic device, for example, a smart phone, a mobile phone, a portable game machine, a netbook computer, or the like, in addition to a television receiver.

As a specific method of realizing a method in which the dedicated glasses are not necessary, there is a method in which an optical device for three-dimensional display in which light of a display image from a two-dimensional display device is deflected in the direction of a plurality of view angles is combined with the two-dimensional display device such as a liquid crystal display on a screen thereof.

A switching type lens array element using a liquid crystal lens has been used. The liquid crystal lens array element is able to electrically switch between the presence or absence of a lens effect. Accordingly, by providing the liquid crystal lens array element on the screen of the two-dimensional display device, it is possible to switch between two display modes of a two-dimensional display mode in a state of not having the lens effect, and a three-dimensional mode in a state of having the lens effect.

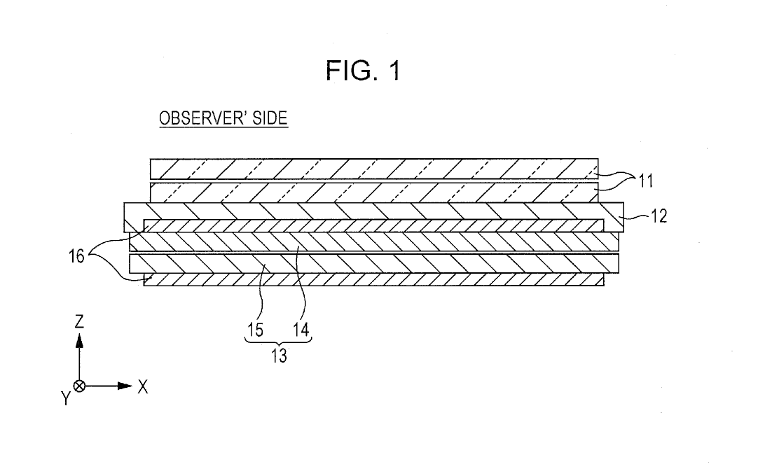

FIG. 1 illustrates a schematic diagram when such a liquid crystal lens is arranged on the liquid crystal display. A liquid crystal lens panel 11 is laminated on an LCD (Liquid Crystal Display) 13 through an optical elastic body 12. Here, the LCD has been continuously described as an example of the display device, however, it is also possible to use a display device such as an organic EL (Electro-Luminescence) panel.

A specific configuration of the LCD 13 is not illustrated, however, it is configured such that an oily transparent liquid crystalline composition (liquid crystal material) is interposed between two transparent substrates, the periphery thereof is sealed by a sealing material, and the liquid crystal material is not leaked. In the two substrates, a color filter substrate (opposing substrate 14) is arranged on the front side, and an array substrate 15 is arranged on the rear side. On the array substrate 15, active elements such as TFT, and electrodes as sub-pixels are built in arrays (arrangement) on the liquid crystal side.

In LCD 13, a set of polarizing plates (polarizing filter) 16 is provided further outside of the front and rear transparent substrates in which the liquid crystal is enclosed. When it is a transmission type LCD 13, light which is output from a light source (backlight) on the rear side which is not shown passes through each element in order of the light source→polarizing plate 16→array substrate 15→transparent electrode of sub-pixels→alignment film→liquid crystal→alignment film→common transparent electrode→opposing substrate 14 (color filter substrate)→polarizing plate 16.

Since the liquid crystal lens panel 11 is laminated on the LCD 13 having such a configuration through the optical elastic body 12, light reaches the liquid crystal lens panel 11 from the polarizing plate 16 through the optical elastic body 12. In addition, it is configured such that the light which has passed through the liquid crystal lens panel 11 reaches the eyes of an observer. The display device including the liquid crystal lens panel 11 having such a configuration is used in a three-dimensional display for naked eyes, or the like.

The liquid crystal lens panel 11 is arranged on the upper side of the LCD 13 (observer's side) in FIG. 1, however, it is also possible to arrange the liquid crystal lens panel on the lower side of the LCD 13 (opposing side from observer). When the liquid crystal lens panel 11 is arranged on the lower side of the LCD 13, it is possible to make the panel a high brightness panel by controlling a view angle of the display device, or by condensing light of a light shielding unit such as wiring or the like.

### Configuration Example of Liquid Crystal Lens Panel 11

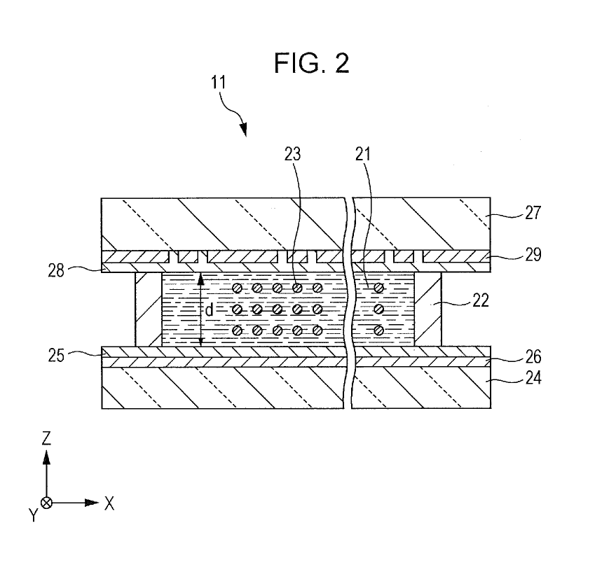

FIG. 2 illustrates a cross-sectional view of the liquid crystal lens panel 11. The liquid crystal lens panel 11 selectively changes a transmission state of rays from the LCD 13 by controlling the lens effect in each region on the screen according to the display mode. The configuration of the liquid crystal lens panel 11 which is illustrated in FIG. 2 is an example, and the configuration, material, or the like can be suitably changed.

The liquid crystal lens panel 11 includes a first substrate 24 and a second substrate 27 which are arranged to face each other with the gap d, and a liquid crystal layer 21 which is arranged therebetween. A spacer 22 which is formed of a glass material or a resin material is arranged on alignment films 25 and 28 so as to evenly maintain the gap d between the first and second substrates 24 and 27. The first and second substrates 24 and 27 are also transparent substrates which are formed of, for example, a glass material, the resin material, or the like.

When the spacer 22 is provided in the liquid crystal layer 21, it is possible to spray the spacer 22 (dispersed spacer) which is formed of the glass material, or the resin material, as described above. In addition, it is also possible to configure the spacer as a photospacer by configuring in a wall shape, or a columnar shape, similarly to the spacer 22. However, according to the embodiment, a case in which the columnar spacer is used will be exemplified, as described below.

A first electrode group 26 in which a plurality of transparent electrodes which are extended in the first direction (X axis direction in the same figure) are arranged in parallel with a gap in the width direction (Y axis direction in the same figure) is formed on the side facing the second substrate 27 on the first substrate 24. The alignment film 25 is also formed on the first substrate 24 through the first electrode group 26.

Similarly, a second electrode group 29 in which the plurality of transparent electrodes which are extended in the second direction which is different from the first direction (Y axis direction in the same figure) are arranged in parallel with a gap in the width direction (X axis direction in the same figure) is formed on the side facing the first substrate 24 on the second substrate 27. The alignment film 28 is also formed on the second substrate 27 through the second electrode group 29.

The liquid crystal layer 21 includes a liquid crystal material 23, and is set such that the lens effect is controlled due to a change in the alignment direction of the liquid crystal material 23 according to a voltage which is applied to the first electrode group 26, and the second electrode group 29. The liquid crystal material 23 includes the anisotropy of the index refractive, and index ellipsoid which has a different refractive index with respect to the light passing, for example, in the longitudinal and lateral direction.

In addition, here, an example in which both the first and second electrode groups 26 and 29 are patterned has been exemplified, however, it is also possible to have a configuration in which only any one of the first and second electrode groups 26 and 29 is patterned.

For example, when using a method such as switching between the length and breadth of the lens, or using other uses, it is possible to configure the electrode as a solid electrode of a transparent electrode such as ITO (Indium Tin Oxide) in which one side of the electrode is not patterned (effective pixel unit).

For example, since the electrodes are controlled due to the application method of electric fields even in one direction of only in the vertical, or in the horizontal direction, the electrode may or may not be patterned. In a case of switching the vertical and horizontal directions, since an electric field is necessary in the direction which is rotated 90 degrees, both sides patterning are necessary such that the electrode pattern is provided in the direction which is rotated 90 degrees, and the electrode is arranged so as to be rotated 90 degrees with the gap d.

When configured in this manner, the solid electrode side is arranged on the observer's side due to static electricity, or the like. The transparent electrode such as ITO is patterned in the other electrode group. For example, it is patterning of a structure in which lines and spaces are repeated in a predetermined direction. In such a striped structure, a refractive index distribution is generated in the electric field between electrodes, it is possible to make function as a lens, and it becomes a structure in which the electrodes are extended in the vertical direction y with respect to the cross-sectional direction X of the lens. The present technology can be applied to the liquid crystal lens panel 11 having such a structure.

### Regarding Height of Spacer

The liquid crystal lens panel 11 and the LCD 13 have a common point that both are configured by interposing the liquid crystal material 23 between a set of substrates. The distance between substrates (cell gap) of the LCD 13 is approximately 2 to 4 μm. The large cell gap of 10 μm or more is necessary for the liquid crystal lens panel 11. In order to obtain such a cell gap, a spacer is provided in the liquid crystal lens panel 11, or the LCD 13. The spacer which is provided in the LCD 13 is not shown in the figure, however, the spacer which is provided in the liquid crystal lens panel 11 is illustrated as the spacer 22 in FIG. 2. Here, descriptions will be continued by exemplifying the spacer 22.

The spacer 22 illustrated in FIG. 2 is, for example, a columnar spacer 22. Here, a case in which a dispersed spacer is used will be considered. The dispersed spacer is circular when seen from the side, however, is configured as a spherical shape when viewed stereoscopically. When the spacer 22 is spherical, the vertical length, or the horizontal length becomes the diameter, and the ratio of the vertical length to the horizontal length is the same.

Since it is necessary to make the vertical length of the spacer longer in order to obtain a larger cell gap by making the spray spacer, it is necessary to make the diameter of the spherical spacer large. Accordingly, as a result, the spacer becomes large. When spraying such a large spacer, there is a possibility of the properties of the liquid crystal lens panel 11 being deteriorated by being affected by the spacer 22. When the liquid crystal lens is applied to a stereoscopic display device, there is a high possibility of influence from crosstalk, or the like due to deterioration of properties of the liquid crystal lens.

In addition, when the spherical spacer 22 is used, the cell gap is secured in a state in which only a portion of the top and bottom of the spherical shape comes into contact with the substrate. In this case, there is a possibility that a ground contact area becomes small, and it is difficult to attain the strength of the cell. In addition, since the spacer is arranged by spraying, it is difficult to control the arrangement of the spacer, and to evenly arrange the spacer. There is a possibility that the optical property is deteriorated since the spacer is not evenly arranged.

In addition, here, it is disclosed that “optical property is deteriorated when the spacer is not evenly arranged”, however, the spacer not being evenly arranged is not an immediate cause of deterioration of the optical property, and the optical property is deteriorated due to the following reason. In addition, in the present specification, “spacer is evenly arranged” means that it is possible to control the position of the spacer 22 to be arranged, and by controlling the arranging position, it is possible to evenly arrange the spacer 22. In addition, this means that it is possible to arrange the spacer 22 at a position at which the optical property is not deteriorated even when it is not even.

A portion at which the spacer 22 is present (periphery of spacer 22) has a tendency for the orientation to be disordered. In addition, since the spacer 22 does not function as a lens, portions which do not function as the lens are included in the lens. Accordingly, the optical property as a lens at portions in which the spacer 22 is present is deteriorated.

For example, when the spacer 22 is concentrated at a portion, there is a high possibility that the optical property as the lens at such a portion is deteriorated. On the contrary, the optical property as the lens at portions in which the spacer 22 is not present is not deteriorated. When portions at which the optical property is deteriorated, and portions at which the optical property is not deteriorated are extremely maldistributed, it leads to the deterioration of functions as the lens in the whole lens. Accordingly, it is preferable that the spacer 22 not be maldistributed in order to scatter portions at which the optical property is deteriorated.

Accordingly, here, the arranging position of the spacer 22 is controlled in order not to make the spacer 22 be maldistributed, and as a result, the descriptions are continued by assuming that the spacers are evenly arranged. In addition, the position where the spacer 22 is arranged is preferably the center portion of the lens, and a control is performed so that the spacer 22 is arranged such a position.

Due to this, it is difficult to control the arranging position of the spacer 22, and it is difficult to secure the larger cell gap due to the spray spacer in which the spacer itself becomes relatively large. Therefore, it is considered to make the columnar spacer 22. As the columnar shape, a polygonal columnar shape such as a square pole, or a column can be applied thereto.

Here, a case of the columnar spacer 22 will be described as an example. When the columnar spacer 22 is created, the height becomes the height d as shown in FIG. 2. In addition, the diameter becomes, for example, the diameter L.

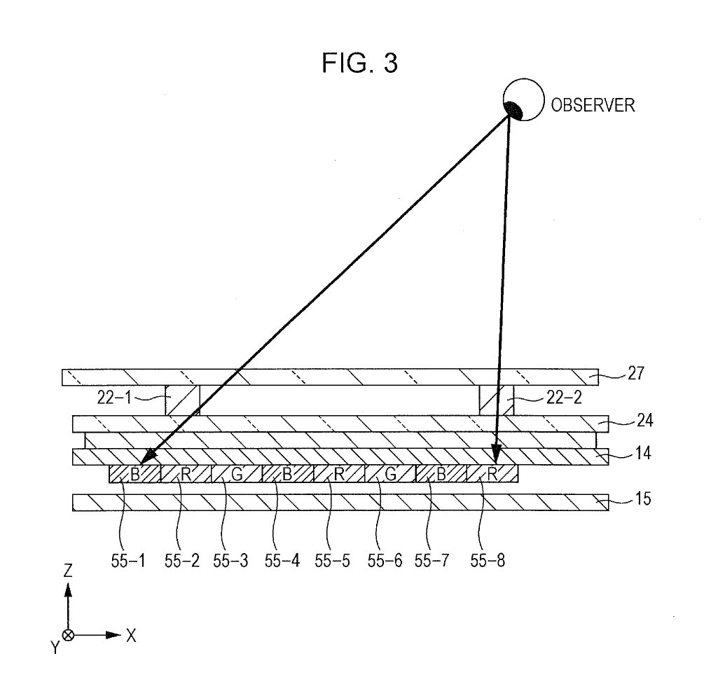

When such as spacer 22 is provided in the liquid crystal lens panel 11, there are cases in which light from the LCD 13 does not appropriately reach an observer due to the spacer 22. This will be described with reference to FIG. 3. FIG. 3 is a diagram in which the liquid crystal lens panel 11, and the LCD 13 are seen from the side similarly to the case shown in FIG. 1, or 2.

The CD 13 according to the embodiment can be applied to a display device in which one pixel is configured by three sub-pixels which output light of each color of R (red), G (green), and B (blue). Here, a display area as a minimum unit configuring a display is referred to as a “sub-pixel”, and a display area which is configured by the sub-pixel of one set (R, G, and B) is referred to as a “pixel”.

In addition, here, a case in which one pixel is configured by three sub-pixels of R (red), G (green), and B (blue) will be continuously described as an example, however, the present technology can be applied to an LCD 13 in which one pixel is configured by another configuration. For example, the present technology can be applied to a case where one pixel is configured by four colors of R (red), G (green), B (blue), and W (white), a case where one pixel is configured by four colors of R (red), G (green), B (blue), and Y (yellow), a case where one pixel is configured by three colors of C (cyan), M (magenta), and Y (yellow), and the like.

A plurality of sub-pixels R, G, and B are arranged in a matrix in the display area of the LCD 13. A description of R denotes a sub-pixel R, a description of G denotes a sub-pixel G, and a description of B denotes a sub-pixel B in FIG. 3, and in the figures which are used in the following descriptions. In addition, a description of sub-pixel R denotes a red sub-pixel, a description of sub-pixel G denotes a green sub-pixel, and a description of sub-pixel B denotes a blue sub-pixel.

The pixels are arranged in the LCD 13, and a part thereof is illustrated in FIG. 3. In FIG. 3, eight pixels of sub-pixel 55-1 to 55-8 which are arranged in the X axis direction are exemplified. The sub-pixel 55-1 is the sub-pixel B, the sub-pixel 55-2 is the sub-pixel R, the sub-pixel 55-3 is the sub-pixel G, and the sub-pixel 55-4 is the sub-pixel B.

In addition, the sub-pixel 55-5 is the sub-pixel R, the sub-pixel 55-6 is the sub-pixel G, the sub-pixel 55-7 is the sub-pixel B, and the sub-pixel 55-8 is the sub-pixel R. A spacer 22-1 of the liquid crystal lens panel 11 is arranged on the sub-pixel R of the sub-pixel 55-2 which is arranged in this manner, and the spacer 22-2 is arranged on the sub-pixel R of the sub-pixel 55-8.

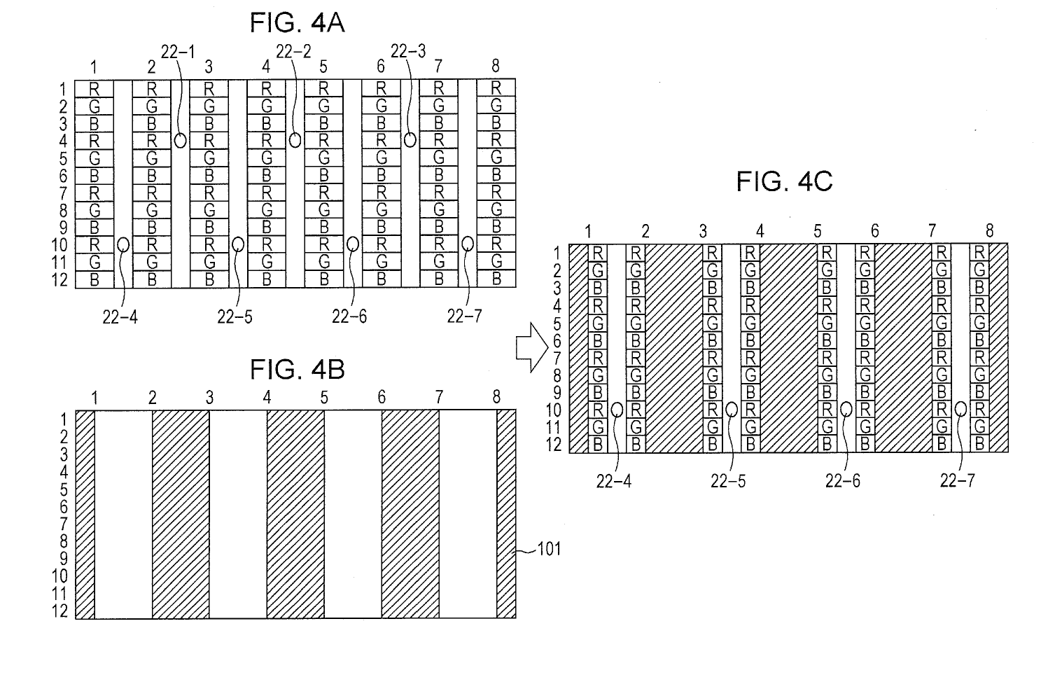

In addition, the LCD 13 also includes the liquid crystal layer, and the spacer is arranged, however, in the following descriptions, the spacer of the LCD 13 is not shown, and only the spacer 22 of the liquid crystal lens panel 11 is shown in the figure. That is, in the figure which will be referred in the following descriptions, the spacer is the spacer of the liquid crystal lens panel 11, but not the spacer of the LCD 13. In addition, for example, in FIG. 4A or the like to be described later, the pixels and the spacer are illustrated in the same figure, however, the pixels are provided in the LCD 13, and the spacer is provided in the liquid crystal lens panel 11.

It is assumed that an observer views a screen which is provided in the LCD 13 from a position shown in FIG. 3. At this time, the observer observes the sub-pixel R of the sub-pixel 55-1 through the spacer 22-1 of the liquid crystal lens panel 11. In addition, the observer observes the sub-pixel R of the sub-pixel 55-2 through the spacer 22-2 of the liquid crystal lens panel 11.

From this, it is considered that the spacer 22-1 of the liquid crystal lens panel 11 or 22-2 influences light from pixels which are provided in the LCD 13. That is, as described above, when the observer observes the sub-pixel R of the sub-pixel 55-1 through the spacer 22-1 of the liquid crystal lens panel 11 the sub-pixel R is not visible due to the spacer 22-1, and there is a possibility of light from the sub-pixel R of the sub-pixel 55-1 not being suitably provided to the observer due to the influence of light from the sub-pixel R being refracted or the like due to the spacer 22-1.

Similarly, there is a possibility that light from the sub-pixel R of the sub-pixel 55-8 is also not suitably provided to the observer due to influence of the spacer 22-2. In addition, when the position of the observer is changed, pixels which are influenced by the spacer 22-1, or 22-2 becomes different. Due to this, there is a possibility of rainbow-like color irregularity occurring, and the irregular colors being observed by the observer.

Here, the liquid crystal lens panel 11 has been described as an example, however, as described with reference to FIG. 4, or the like, the present technology can also be applied to a case in which a parallax barrier is used instead of the liquid crystal lens panel 11. For example, in a method of a stereoscopic display using the parallax barrier, there is a parallax barrier method. When providing a stereoscopic image to an observer using the parallax barrier method, there is a case in which a liquid crystal panel is used as the barrier.

When the liquid crystal panel is used, there is a possibility of the rainbow-like color irregularity occurring, similarly to the above described case due to influence of the spacer which is included in the liquid crystal panel. Accordingly, when there is a possibility that such irregular color occurs, the present technology can be applied.

In addition, it is also possible to apply the present technology to a device in which light is distributed to a specific viewpoint by a barrier, or a lens such as an optical device which is used in a case of multiple viewpoints which are respectively provided to a plurality of observers who are observing different images from different positions, and it is possible to prevent the irregular color from occurring by applying the present technology.

In addition, though it is not shown, the spacer is also included in the LCD 13, and the present technology to be described later can also be applied to a display unit including the spacer like LCD 13.

In addition, in descriptions referring to FIGS. 1 to 3, an example has been described in which the liquid crystal lens panel 11 is laminated on the LCD 13 on the observer side, however, the present technology can be applied to a case in which the liquid crystal lens panel 11 is laminated on the LCD 13 on the side which is not the observer side, that is laminated on the backlight side.

Like this, the structure is one which is provided between the predetermined substrates such as the spacer, and it is considered that the structure influences light from the display unit when an element or a device including the structure is laminated on the display unit such as the LCD 13. The influence causes the irregular color to occur, and as a reason for causing the irregular color, or the like, the distance between the structure and the display unit can be considered. An example thereof has been described with reference to FIG. 3.

### Regarding Relationship Between Arrangement of Pixels, Barrier, and Spacer

Such points will be further described with reference to FIGS. 4A to 4C. FIG. 4A is a diagram of when the LCD 13 which is mounted with the liquid crystal lens panel 11 is viewed from the observer side. In the figure, white circles denote the spacers which are provided on the liquid crystal lens panel 11.

In the LCD 13 which is illustrated in FIG. 4A, one pixel is configured by the sub-pixels R, G, and B. In the descriptions below, as a description denoting the position of the sub-pixel, it is written as a sub-pixel 1-2. In writing of the sub-pixel 1-2, “1” denotes that the sub-pixel is located first when counting from the left in the X axis direction (FIGS. 3), and “2” denotes that the sub-pixel is located second when counting from above in the Y axis direction (FIG. 3). For example, the sub-pixel 1-1 denotes the sub-pixel R which is leftmost and on the top in FIG. 4A.

FIG. 4A illustrates arrangements of pixels, FIG. 4B is a case in which a parallax barrier is used instead of the liquid crystal lens panel 11, and denotes the shape of an opening portion of the parallax barrier, and FIG. 4C illustrates how the pixels are viewed from the opening portion. In addition, descriptions of the liquid crystal lens panel 11 will be continued, however, since it is possible to apply the embodiment to a barrier method such as the parallax barrier, the parallax barrier will be exemplified in FIG. 4B.

In the arrangement of the pixels which are illustrated in FIG. 4A, sub-pixels 1-1 to 8-1 on the top are set to the sub-pixel R, sub-pixels 1-2 to 8-2 on the second row from the top are set to the sub-pixel G, and the sub-pixels 1-3 to 8-3 on the third row from the top are set to the sub-pixel B. In the vertical direction, the arrangement of the sub-pixels R, G, and B is repeated.

The spacer 22-1 of the liquid crystal lens panel 11 is provided between the sub-pixel R of the sub-pixel 2-4 and the sub-pixel R of the sub-pixel 3-4. The spacer 22-2 is provided between the sub-pixel R of the sub-pixel 4-4 and the sub-pixel R of the sub-pixel 5-4. The spacer 22-3 is provided between the sub-pixel R of the sub-pixel 6-4 and the sub-pixel R of the sub-pixel 7-4.

The spacer 22-4 is provided between the sub-pixel R of the sub-pixel 1-10 and the sub-pixel R of the sub-pixel 2-10. The spacer 22-5 is provided between the sub-pixel R of the sub-pixel 3-10 and the sub-pixel R of the sub-pixel 4-10. The spacer 22-6 is provided between the sub-pixel R of the sub-pixel 5-10 and the sub-pixel R of the sub-pixel 6-10. The spacer 22-7 is provided between the sub-pixel R of the sub-pixel 7-10 and the sub-pixel R of the sub-pixel 8-10.

In this manner, the spacer 22 is provided on the row of the sub-pixel R. Since lots of light is omitted in the periphery of the spacer 22, and there is a case in which opening of the LCD 13 is not even since opening of RGB is adjusted in order to adjust color (whiteness), the spacer is arranged in the same color. However, when the spacer is arranged in the same color in this manner, as described with reference to FIG. 3, there is a possibility that deterioration of image quality such as the irregular color may occur.

FIG. 4B is a diagram which illustrates an example of an opening portion of a parallax barrier 101. The opening portion of the parallax barrier 101 which is illustrated in FIG. 4B is a linear barrier. One opening portion of the parallax barrier 101 has a width of a size of one sub-pixel at a position which straddles two sub-pixels. For example, the opening portion has a size which straddles the sub-pixel 1-1 and the sub-pixel 2-1.

When the parallax barrier 101 illustrated in FIG. 4B is overlapped with the LCD 13 having arrangements of pixels illustrated in FIG. 4A thereon, the pixels are viewed from each slit as illustrated in FIG. 4C. When referring to FIG. 4C, a half of the sub-pixel R of the sub-pixel 1-1, and a half of the sub-pixel R of the sub-pixel 2-1 are viewed from the opening portion of the parallax barrier 101. A half of the sub-pixel G of the sub-pixel 1-2, and a half of the sub-pixel G of the sub-pixel 2-2 are viewed thereunder. A half of the sub-pixel B of the sub-pixel 1-3, and a half of the sub-pixel B of the sub-pixel 2-3 are viewed further thereunder. Similarly, in other opening portions, it is configured such that the arranged sub-pixels are viewed from the opening portion.

Light from sub-pixels as shown in FIG. 4C is provided to an observer when seen from one predetermined viewpoint. In this manner, an opening portion (slit) is provided so that sub-pixels configuring one pixel, such as sub-pixels of R, G, and B in the vertical direction, become even for the color balance of images in each parallax in the parallax barrier 101 shown in FIG. 4B. Accordingly, when providing a 3D image, or a multi-viewpoint image, it is possible to provide an image in a state in which the color balance is regulated well.

However, as described above, there is a possibility that deterioration of image quality such as the irregular color occurs, and a possibility that such deterioration of image quality may occur even in an on state, or in an off state of the parallax barrier 101.

### Regarding Case in Which Spacers are Randomly Provided

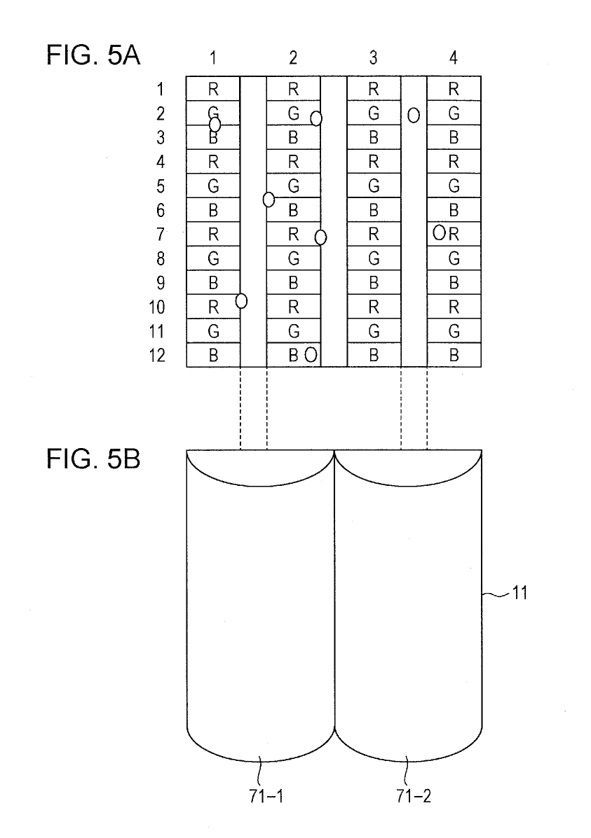

FIG. 5A is a diagram which illustrates an example of a case in which the spacer 22 is randomly provided. In addition, FIG. 5B is a diagram which artificially illustrates a lens of the liquid crystal lens panel 11. In the pixel arrangement in FIG. 5A, similarly to FIG. 4A, the sub-pixel R is arranged on the first row, the sub-pixel G is arranged on the second row, and the sub-pixel B is arranged on the third row. Such alignment of sub-pixels R, G, and B is repeated.

Since the spacer 22 is randomly arranged, for example, the spacer is arranged at a position which straddles the sub-pixel G of the sub-pixel 1-2 and the sub-pixel B of the sub-pixel 1-3, a position on the upper right of the sub-pixel R of the sub-pixel 1-10, or the like.

By randomly arranging the spacer 22 in this manner, the spacer 22 is randomly arranged in the screen, and it is possible to suppress the occurrence of irregular color of the rainbow shape. However, similarly to the case in which the spray spacer is sprayed, when randomly arranging the spacer 22, the spacer 22 is localized, for example, and there is a possibility that the spacer is not evenly arranged.

There is a possibility that the optical property becomes different between a portion at which the spacer 22 is localized and a portion at which the spacer is not localized, and there is a possibility that the image quality is deteriorated. For example, there is a possibility of deteriorating the crosstalk. In particular, in a case of the liquid crystal lens panel 11, when the spacer 22 is localized, it influences the refraction distribution of the lens, accordingly, crosstalk easily occurs. Therefore, it is considered preferable to control the spacer 22 so as not to be arranged at a position in which deterioration in functions as the lens such as the crosstalk or the like occur.

In addition, when providing the liquid crystal lens panel 11 as shown in FIG. 5B, it is preferable to arrange the spacer 22 at the center of each lens configuring the liquid crystal lens panel 11. The black matrix of the LCD 13 is located at the center portion of each of the lenses 71-1 and 71-2 of the liquid crystal lens panel 11 which is shown in FIG. 5B.

By arranging the black matrix, or the spacer 22 at the center of the lens 71, it is possible to suppress deterioration in the optical property. However, as shown in FIG. 5A, when there is no spacer 22 at the center portion of the lens 71, there is a possibility that the optical property of the lens 71 may deteriorate due to an influence of the spacer 22. Accordingly, it is considered to be preferable that the spacer 22 is arranged at the center portion of each lens configuring the liquid crystal lens panel 11.

### Regarding Arrangement of First Spacer

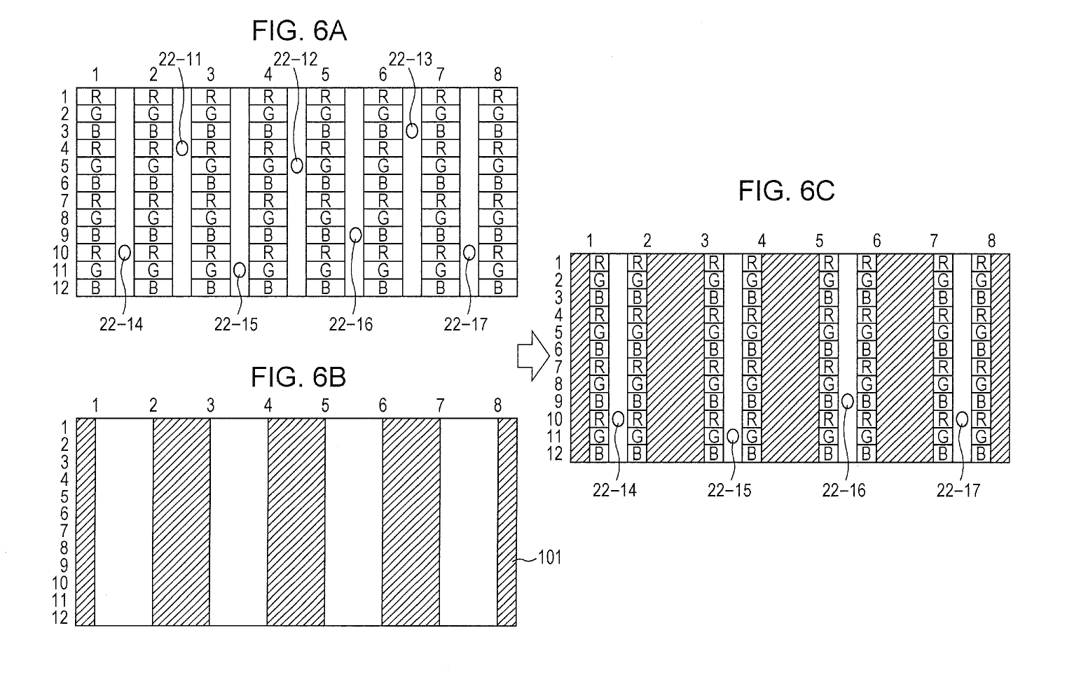

Therefore, it is considered to be the optimal arrangement of the spacer 22 in which the deterioration in image quality is suppressed when the spacer 22 is evenly arranged, and is not arranged in the same color. An example of such an arrangement of the spacer 22 is illustrated in FIGS. 6A to 6C.

FIG. 6A is a diagram which illustrates the relationship between the pixel and the arrangement of the spacer. The arrangement of the pixels illustrated in FIG. 6A is the same as the arrangement of the pixels illustrated in FIG. 4A, or 5A. The spacer 22-11 of the liquid crystal lens panel 11 is provided between the sub-pixel R of the sub-pixel 2-4 and the sub-pixel R of the sub-pixel 3-4. The spacer 22-12 is provided between the sub-pixel G of the sub-pixel 4-5 and the sub-pixel G of the sub-pixel 5-5. The spacer 22-13 is provided between the sub-pixel B of the sub-pixel 6-3 and the sub-pixel B of the sub-pixel 7-3.

The spacer 22-14 is provided between the sub-pixel R of the sub-pixel 1-10 and the sub-pixel R of the sub-pixel 2-10. The spacer 22-15 is provided between the sub-pixel G of the sub-pixel 3-11 and the sub-pixel G of the sub-pixel 4-11. The spacer 22-16 is provided between the sub-pixel B of the sub-pixel 5-9 and the sub-pixel B of the sub-pixel 6-9. The spacer 22-17 is provided between the sub-pixel R of the sub-pixel 7-10 and the sub-pixel R of the sub-pixel 8-10.

In addition, each of the spacers 22-11 to 22-17 is arranged at the portions of the black matrix, respectively.

In the example illustrated in FIG. 6A, the spacers 22-11 to 22-17 are present not only in the sub-pixel R, but also in the sub-pixels G, and B. That is, differently from the case in FIG. 4A in which the spacer 22 is provided in the sub-pixels of the same color as each other, the spacer 22 is provided in the sub-pixels of different color from each other. Accordingly, it is possible to prevent the irregular color of the rainbow shape.

In addition, in the example illustrated in FIG. 6A, the spacers 22-11 to 22-17 are arranged regularly, not randomly. Accordingly, it is possible to prevent the deterioration in image quality such as the crosstalk which occurs when the spacer 22 is localized.

In the example illustrated in FIG. 6A, it is set such that the spacer 22 is not linearly arranged in the horizontal direction (X axis direction). Since the sub-pixels of the same color are arranged in the horizontal direction, it is possible to prevent the spacer 22 from being arranged only in the sub-pixels of a specific color, by not linearly arranging the spacer 22 in the horizontal direction.

In addition, the spacers 22 which are neighboring in the horizontal direction are in relationships of being arranged at positions deviated upward, or downward. For example, the spacer 22-12 neighboring the spacer 22-11 in the horizontal direction is arranged downward in the vertical direction with respect to the spacer 22-11. Similarly, the spacer 22-13 neighboring the spacer 22-12 in the horizontal direction is arranged upward in the vertical direction with respect to the spacer 22-12.

A relationship with the parallax barrier will be described. FIG. 6B is a diagram which illustrates an example of the parallax barrier. The parallax barrier 101 which is illustrated in FIG. 6B is the same parallax barrier 101 as the parallax barrier 101 illustrated in FIG. 4B.

When the parallax barrier 101 illustrated in FIG. 6B is superimposed on the LCD 13 having the arrangement of the sub-pixels illustrated in FIG. 6A, pixels are seen from each slit as illustrated in FIG. 6C. When referring to FIG. 6C, a half of the sub-pixel R of the sub-pixel 1-1, and a half of the sub-pixel R of the sub-pixel 2-1 are seen from the opening portion of the parallax barrier 101. A half of the sub-pixel G of the sub-pixel 1-2, and a half of the sub-pixel G of the sub-pixel 2-2 are seen thereunder. A half of the sub-pixel B of the sub-pixel 1-3, and a half of the sub-pixel B of the sub-pixel 2-3 are seen further thereunder. It is configured such that the arranged sub-pixels are seen from the opening portion, similarly, in other opening portions, as well.

When seen from a predetermined viewpoint, light from sub-pixels as illustrated in FIG. 6C is provided to an observer. In this manner, an opening portion (slit) is provided so that the sub-pixels configuring one pixel, such as the sub-pixels of R, G, and B in the vertical direction, become even for a color balance of images in each parallax in the parallax barrier 101 illustrated in FIG. 6B.

When referring to FIG. 6C again, the spacers 22-14 to 22-17 are respectively present in each slit. The spacers 22-14 to 22-16 are arranged in a positional relationship in which the spacers are deviated in the up and down direction, respectively. For example, when focusing on the spacer 22-14, other spacers 22-15, and 22-16 are arranged above, or below with respect to the spacer 22-14.

In this manner, when the gap at which the spacers 22 are arranged, and the gap at which the sub-pixels of the same color are arranged (for example, gap at which sub-pixel R is arranged) are different, it is possible to set such that the spacer 22 is not arranged in the vicinity of the sub-pixels of the same color.

In this manner, the spacer 22 is not localized by regular arrangement thereof, the irregular color or the like is prevented from occurring by arranging the spacer 22 evenly in the image, and arranging the spacer so as not to present in the same color, and as a result, it is possible to control so that color shading and the crosstalk do not occur.

In FIGS. 6A to 6C, the parallax barrier 101 has been exemplified, however, even in a case of the liquid crystal lens panel 11, it is possible to control so that the irregular color or the like does not occur, and the crosstalk or the like does not occur, using the arrangement of the spacer 22 illustrated in FIG. 6A.

However, in a case of the liquid crystal lens panel 11, as described referring to FIGS. 5A and 5B, it is preferable to arrange the spacer 22 at the center portion of the lens configuring the liquid crystal lens panel 11. When assuming the slit of the parallax barrier 101 illustrated in FIG. 6B as the lens, for example, the spacer 22-11 is present at a position which is the end of the lens. Similarly, the spacers 22-12 and 22-13 are also present at the end of the lens. In such a case, the arranging position of the spacer 22 is controlled such that color becomes even (arranged by being distributed into RGB) in the spacers 22-14 to 22-17 which are not present at the end of the lens. Such an arrangement is illustrated in FIG. 6A.

### Regarding Arrangement of Second Spacer

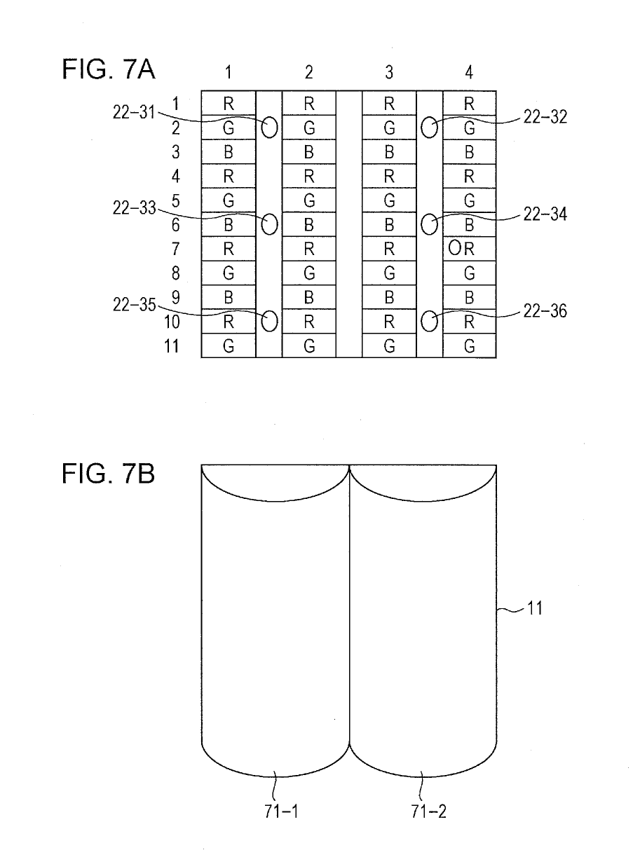

Subsequently, an arrangement of the spacer 22 when the liquid crystal lens panel 11 is used will be described. FIG. 7A has the same pixel arrangement as that in FIG. 6A. The spacer 22 of the liquid crystal lens panel 11 is present at a position corresponding to the black matrix in the example illustrated in FIG. 7A.

The spacer 22-31 of the liquid crystal lens panel 11 is provided between the sub-pixel G of the sub-pixel 1-2 and the sub-pixel G of the sub-pixel 2-2. The spacer 22-32 is provided between the sub-pixel G of the sub-pixel 3-2 and the sub-pixel G of the sub-pixel 4-2. The spacer 22-33 is provided between the sub-pixel B of the sub-pixel 1-6 and the sub-pixel B of the sub-pixel 2-6. The spacer 22-34 is provided between the sub-pixel B of the sub-pixel 3-6 and the sub-pixel B of the sub-pixel 4-6.

The spacer 22-35 is provided between the sub-pixel R of the sub-pixel 1-10 and the sub-pixel R of the sub-pixel 2-10. The spacer 22-36 is provided between the sub-pixel R of the sub-pixel 3-10 and the sub-pixel R of the sub-pixel 4-10.

In the example illustrated in FIG. 7A, the spacers 22-31 to 22-36 are present by being distributed into each color of sub-pixels R, G, and B. That is, differently from the case in FIG. 4A in which the spacer 22 is provided in the sub-pixels of the same color, the spacer 22 is provided in the sub-pixels of different colors. Accordingly, it is possible to prevent the irregular color of the rainbow shape.

In addition, in the example illustrated in FIG. 7A, the arranging positions of the spacers 22-31 to 22-36 are controlled so as to be arranged regularly, not randomly. Accordingly, it is possible to prevent the spacer 22 from being localized, and to disperse portions in which the optical property is deteriorated. Further, since it is possible to control the spacer 22 so as not to be arranged at positions at which the optical property is deteriorated, the deterioration in the optical property can be prevented. For this reason, it is possible to prevent the deterioration in the image quality such as the crosstalk.

In addition, as illustrated in FIG. 7B, it is possible to suppress the deterioration in the optical property by arranging the lens of the liquid crystal lens panel 11. A part of the liquid crystal lens panel 11 is illustrated in FIG. 7B. The black matrix of the LCD 13 is located at respective center portion of the lenses 71-1 and 71-2. Further, the spacers 22-31 to 22-36 are arranged at the portion of the black matrix. Accordingly, the spacers 22-31 to 22-36 are arranged at the center portion of the lens 71-1, or 71-2, respectively.

In this manner, it is possible to suppress the deterioration in the optical property of the liquid crystal lens panel 11 by arranging the spacer 22 at the center portion of the lens 71.

### Regarding Arrangement of Third Spacer

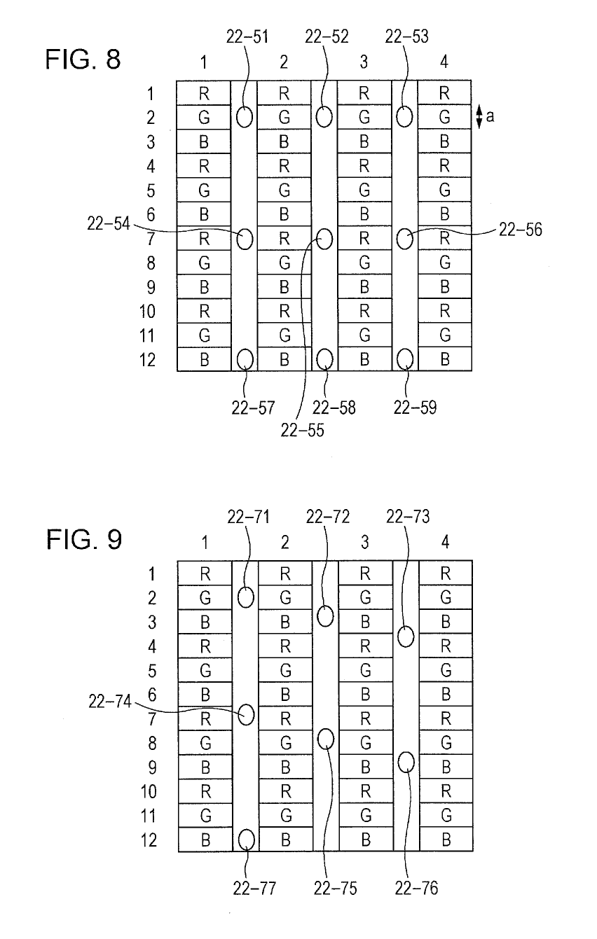

Subsequently, another arrangement of the spacer 22 of the liquid crystal lens panel 11 will be described. FIG. 8 illustrates an arrangement of the same pixels as that in FIG. 7A. The spacer 22 of the liquid crystal lens panel 11 is present at a position corresponding to the black matrix in the example illustrated in FIG. 8.

The spacer 22-51 of the liquid crystal lens panel 11 is provided between the sub-pixel G of the sub-pixel 1-2 and the sub-pixel G of the sub-pixel 2-2. The spacer 22-52 is provided between the sub-pixel G of the sub-pixel 2-2 and the sub-pixel G of the sub-pixel 3-2. The spacer 22-53 is provided between the sub-pixel G of the sub-pixel 3-2 and the sub-pixel G of the sub-pixel 4-2.

The spacer 22-54 is provided between the sub-pixel R of the sub-pixel 1-7 and the sub-pixel R of the sub-pixel 2-7. The spacer 22-55 is provided between the sub-pixel R of the sub-pixel 2-7 and the sub-pixel R of the sub-pixel 3-7. The spacer 22-56 is provided between the sub-pixel R of the sub-pixel 3-7 and the sub-pixel R of the sub-pixel 4-7.

The spacer 22-57 is provided between the sub-pixel B of the sub-pixel 1-12 and the sub-pixel B of the sub-pixel 2-12. The spacer 22-58 is provided between the sub-pixel B of the sub-pixel 2-12 and the sub-pixel B of the sub-pixel 3-12. The spacer 22-59 is provided between the sub-pixel B of the sub-pixel 3-12 and the sub-pixel B of the sub-pixel 4-12.

In the example illustrated in FIG. 8, the spacers 22-51 to 22-59 are present by being distributed into each color of sub-pixels R, G, and B. Accordingly, it is possible to prevent the irregular color of the rainbow shape. In addition, the spacers 22-51 to 22-56 are arranged at portions of the black matrix of the LCD 13, and the black matrix is arranged at the center portion of each lens of the liquid crystal lens panel 11, thereby suppressing the deterioration in the optical property of the liquid crystal lens panel 11.

In addition, in the example illustrated in FIG. 8, the arranging positions of the spacers 22-51 to 22-56 are controlled so that the spacers are arranged regularly, not randomly. Accordingly, it is possible to prevent the spacer 22 from being localized, and to disperse portions in which the optical property is deteriorated. Further, since it is possible to control the spacer 22 so as not to be arranged at positions at which the optical property is deteriorated, the deterioration in the optical property can be prevented. For this reason, it is possible to prevent the deterioration in the image quality, such as the crosstalk.

The pixel arrangement illustrated in FIG. 8 is based on a rule of being linearly arranged when seen in the horizontal direction. In addition, when seen in the vertical direction, the pixel arrangement is based on a rule of interposing four sub-pixels between the spacers. For example, four pixels of the sub-pixel B of the sub-pixel 1-3, the sub-pixel R of the sub-pixel 1-4, the sub-pixel G of the sub-pixel 1-5, and the sub-pixel B of the sub-pixel 1-6 are present between the neighboring spacer 22-51 and the spacer 22-54.

In addition, similarly, for example, four pixels of the sub-pixel G of the sub-pixel 1-8, the sub-pixel B of the sub-pixel 1-9, the sub-pixel R of the sub-pixel 1-10, and the sub-pixel G of the sub-pixel 1-11 are present between the neighboring spacer 22-54 and the spacer 22-57.

The arrangement of the spacer 22 which is illustrated in FIG. 7A will be referred to again. Similar to the pixel arrangement in FIG. 8, the arrangement of the spacer 22 which is illustrated in FIG. 7A is also based on the rule of being linearly arranged when seen in the horizontal direction. In addition, when seen in the vertical direction, the arrangement of the spacer is based on a rule of interposing three sub-pixels between spacers. For example, three sub-pixels of the sub-pixel B of the sub-pixel 1-3, the sub-pixel R of the sub-pixel 1-4, and the sub-pixel G of the sub-pixel 1-5 are present between the neighboring spacer 22-31 and the spacer 22-33.

In this manner, when a predetermined number of sub-pixels are present between the neighboring spacers 22 when seen in the vertical direction, it is possible to prevent the spacer 22 is arranged only in the sub-pixels of the same color, and to prevent the spacers are localized. How many sub-pixels are arranged between the neighboring spacers 22 is determined as follows.

A case is considered in which one pixel is configured by three sub-pixels, and it is assumed that the spacers 22 are arranged in the sub-pixels of the same color. For example, in FIG. 8, it is assumed that the spacer 22 is present at portions of the sub-pixel G of the sub-pixel 1-2, and the sub-pixel G of the sub-pixel 1-5 which is neighboring in the vertical direction. In this case, two sub-pixels of the sub-pixel B of the sub-pixel 1-3, and the sub-pixel R of the sub-pixel 1-4 are present between the sub-pixel G of the sub-pixel 1-2 and the sub-pixel G of the sub-pixel 1-5.

In other words, here, the size of one sub-pixel in the vertical direction is set to “a” as illustrated in the sub-pixel G of the sub-pixel 4-2 in FIG. 8. Here, descriptions will be continued by setting the size of one sub-pixel in the vertical direction “a”, however, the distance between the sub-pixels (pitch of sub-pixel) may be set to “a”. When placing “a” in this manner, as illustrated in FIG. 7A, the situation in which two sub-pixels are present between the sub-pixel G of the sub-pixel 1-2 and the sub-pixel G of the sub-pixel 1-5 can be the situation in which the sub-pixel G of the sub-pixel 1-2 and the sub-pixel G of the sub-pixel 1-5 are separated by 3a.

From this point, it is a case in which one pixel is configured by three sub-pixels, and the sub-pixels which are separated by 3a are the same color as each other. That is, when the spacer 22 is arranged at a position which is being separated by 3a, the spacer 22 is arranged in the sub-pixels of the same color. It is also similar when it is a distance of a multiple of 3a, such as 6a, or 9a.

In order not to make the spacer 22 be arranged in the sub-pixels of the same color, it is preferable that the spacer be set to a value other than a multiple of 3a such as 1a, 2a, 4a, 5a, 7a, . . . . In addition, the value may not be an integer value. Here, when referring to FIG. 8 again, in FIG. 8, the spacer 22-51 and the spacer 22-54 are separated by 5a, and the spacer 22-54 and the spacer 22-57 are also separated by 5a. That is, in the example illustrated in FIG. 8, the spacer 22 is arranged based on a rule of being arranged at a position separated by 5a.

Referring to FIG. 7A again, in FIG. 7A, the spacer 22-31 and the spacer 22-33 are separated by 4a, and the spacer 22-33 and the spacer 22-35 are also separated by 4a. That is, in the example illustrated in FIG. 7A, when seen in the vertical direction, the spacer 22 is arranged based on a rule of being arranged at a position which is separated by 4a.

In this manner, when the spacer 22 is arranged at a position which is not a multiple of the number of colors configuring one pixel, it is possible to arrange the spacer 22 evenly on the entire screen, and not to arrange the spacer in the sub-pixels of the same color.

In addition, in this case, the spacer 22 may be set to values other than a multiple of 3a such as 1a, 2a, 4a, 5a, 7a, . . . , however, the value is set according to an intensity, or an optical property which is necessary for the liquid crystal lens panel 11.

In FIG. 7A, or 8, the size of the sub-pixel is illustrated to be the same as a whole, however, there is a case in which the size of the sub-pixel is designed to be different depending on color. For example, there is a case in which the sizes of the sub-pixels become different, respectively, like the size a of the sub-pixel R, the size b of the sub-pixel G, and the size c of the sub-pixel B.

When the shapes of the sub-pixels are different in this manner, in the above description, a portion which is described as 3a becomes (a+b+c). In addition, the gap of arrangement of the spacer 22 is set to a distance which is not a multiple of the (a+b+c). For example, it is set to a distance of (2a+b+c), (a+2b+c), (a+b+2c), (2a+2b+c), (a+2b+2c), . . . .

In the following description, the description will continue with an example in which the size of the sub-pixel is the same, and the length in the vertical direction is “a”.

### Regarding Arrangement of Fourth Spacer

In this manner, when the arranging position of the spacer 22 is set based on the size of the sub-pixel, as illustrated in FIG. 7A, or 8, it is possible to make the spacer 22 be arranged in a line when seen in the horizontal direction. In this case, since a position of starting the arrangement of the spacer 22 is the same, the spacer 22 is arranged at the same position in each column.

In FIG. 9, arranging positions of the spacers 22 in a case in which the spacers 22 are not arranged in a line when seen in the horizontal direction is illustrated. In the arrangement of the spacers 22 illustrated in FIG. 9, since positions at which the arrangement of the spacer 22 is started is different, the spacer 22 is arranged at a different position in each row.

Even in the arrangement of the spacer 22 illustrated in FIG. 9, the spacers 22-71 to 22-76 are respectively arranged in the liquid crystal lens panel 11 corresponding to the top of the black matrix.

The spacer 22-71 of the liquid crystal lens panel 11 is provided between the sub-pixel G of the sub-pixel 1-2 and the sub-pixel G of the sub-pixel 2-2. The spacer 22-72 is provided between the sub-pixel G of the sub-pixel 2-3 and the sub-pixel G of the sub-pixel 3-3. The spacer 22-73 is provided between the sub-pixel R of the sub-pixel 3-4 and the sub-pixel R of the sub-pixel 4-4.

When seen in the vertical direction, the spacers 22-71, 22-72, and 22-73 are arranged by being deviated by 1 sub-pixel. In each row, the spacers 22-71, 22-72, and 22-73 are respectively set to the top, and the spacer 22 is regularly arranged with a distance of 5a.

For example, on the lower side of the spacer 22-71, the spacer 22-74 is arranged between the sub-pixel R of the sub-pixel 1-7 and the sub-pixel R of the sub-pixel 2-7 which are separated by 5a. In addition, on the lower side of the spacer 22-74, the spacer 22-77 is arranged between the sub-pixel B of the sub-pixel 1-12 and the sub-pixel B of the sub-pixel 2-12 which are separated by 5a. Even in other rows, similarly, the spacer 22 is arranged with the gap of 5a.

Even in the example illustrated in FIG. 9, the spacers 22-71 to 22-77 are present by being distributed into each color of the sub-pixels R, G, and B. Accordingly, it is possible to prevent the irregular color of the rainbow shape. In addition, it is possible to suppress the deterioration in the optical property of the liquid crystal lens panel 11 by arranging the spacers 22-71 to 22-77 at portions of the black matrix of the LCD 13, and to arrange the black matrix at the center portion of each lens of the liquid crystal lens panel 11.

In addition, in the example which is illustrated in FIG. 9, the spacers 22-71 to 22-77 are arranged regularly, not randomly. Accordingly, it is possible to prevent the deterioration in the image quality such as the crosstalk which occurs when the spacer 22 is localized.

### Regarding Arrangement of Fifth Spacer

The arrangement of the spacer 22 illustrated in FIG. 9 will be referenced again. Among spacers 22 which are illustrated in FIG. 9, the spacers 22-71, 22-74, and 22-77 are arranged by being neighbored respectively, in the vertical direction. The spacers 22-71, 22-74, and 22-77 are arranged at positions of the sub-pixels G, R, and B. Accordingly, the spacer 22 is arranged by being distributed into RGB in the vertical direction.

In addition, for example, the spacers 22-71, 22-72, and 22-73 are spacers 22 which are close to each other in the horizontal direction, and these spacers 22 are arranged at positions of the sub-pixels G, B, and R, respectively. Accordingly, the spacers 22 are arranged by being distributed into RGB in the horizontal direction, as well.

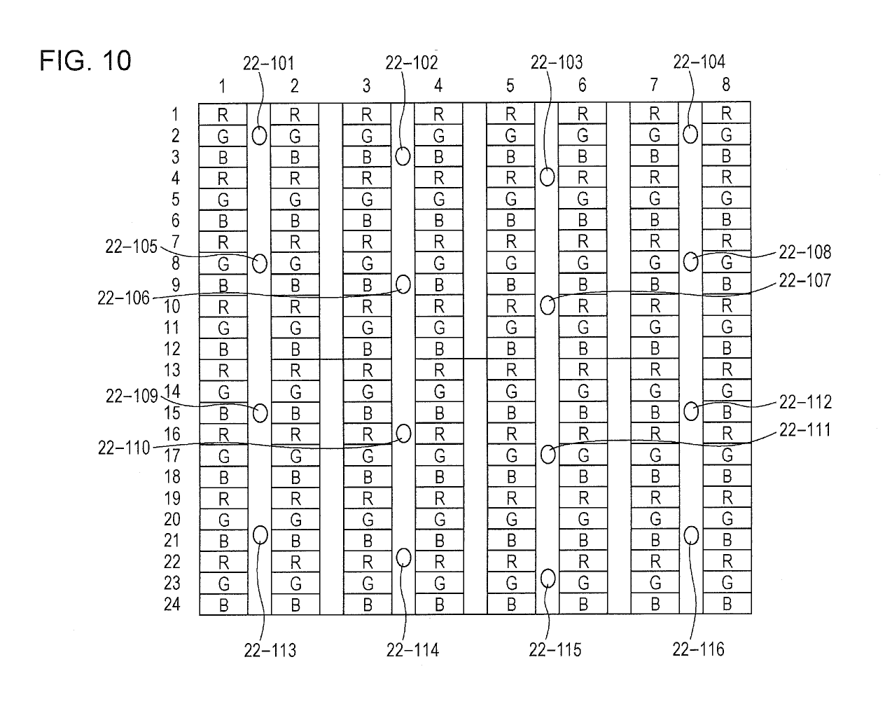

In this manner, it is naturally possible to arrange the spacers 22 by distributing into RGB in the respective vertical direction and horizontal direction, however, it is also possible to arrange the spacers 22 into the RGB in any one of the vertical direction and horizontal direction. In addition, it is not necessary for the neighboring spacers 22 to necessarily be arranged at sub-pixels of different color. Such an example is illustrated in FIG. 10.

Even in the example illustrated in FIG. 10, the arrangement of pixels is the same as that in FIG. 9, or the like. FIG. 10 illustrates the spacers 22-101 to 22-116. For example, the spacers 22 in the vertical direction having the spacer 22-101 as the top are arranged with the gap of 6a, or 7a. The spacer 22-105 is arranged at a position which is separated by 6a to the lower side of the spacer 22-101, and the spacer 22-109 is arranged at a position which is separated by 7a to the lower side of the spacer 22-105.

Further, the spacer 22-113 is arranged at a position which is separated by 6a to the lower side of the spacer 22-109. In addition, though not illustrated, the subsequent spacer is provided at a position which is separated by 7a to the lower side of the spacer 22-113, if it is based on the rule.

The spacers 22-101, 22-105, 22-109, and 22-113 are arranged in this order in the vicinity of the sub-pixel G, the sub-pixel G, the sub-pixel B, and the sub-pixel B. When considering a spacer which is not illustrated, the spacer is also arranged in the vicinity of the sub-pixel R.

According to the arrangement, there is a case in which the neighboring spacers 22 are arranged in the vicinity of the sub-pixels of the same color in the vertical direction, however, the spacers 22 are arranged by being distributed into RGB.

The spacers are arranged by being close to each other in the horizontal direction. For example, the spacers 22-101, 22-102, and 22-103 are arranged in the vicinity of the sub-pixels G, B, and R in this order. In this case, the spacers 22 which are linearly arranged in the obliquely downward direction are arranged by being distributed into RGB.

Even in the example which is illustrated in FIG. 10, the spacers 22-101 to 22-116 are present by being distributed into each color of the sub-pixels of R, G, and B in the vertical direction, and in the direction which is slanted to the right. Accordingly, it is possible to prevent the irregular color of the rainbow shape. In addition, the spacers 22-101 to 22-116 are arranged at positions of the black matrix of the LCD 13, and the black matrix is arranged so as to be located at the center portion of each lens of the liquid crystal lens panel 11, thereby suppressing the deterioration of the optical property of the liquid crystal lens panel 11.

In addition, in the example illustrated in FIG. 10, the 22-101 to 22-116 are regularly, not randomly, arranged. Accordingly, it is possible to prevent the deterioration in the image quality such as the crosstalk which occurs when the spacer 22 is localized.

### Regarding Arrangement of Sixth Spacer

For example, the spacer 22 which is illustrated in FIG. 9 has been described to be arranged with the gap of 5a in the vertical direction. In addition, the spacer 22 which is illustrated in FIG. 10 has been described as being arranged with the gap of 6a, or 7a in the vertical direction. In this manner, the gap when arranging the spacer 22 has been described as a preset value. However, the value relating to the gap may be a value which is randomly set, not a fixed value.

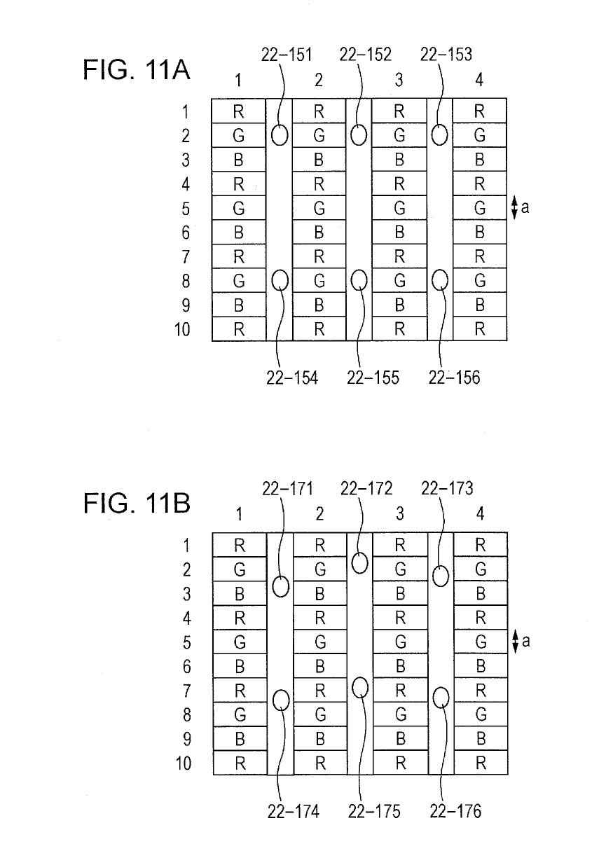

A case in which the gap of arranging the spacer 22 is randomly set will be described with reference to FIGS. 11A and 11B. FIG. 11A illustrates a basic arrangement of the spacer 22, and a diagram is illustrated in FIG. 11B in which the spacer 22 which is deviated upward, or downward using values which are randomly generated from the basic position of the spacer 22 is arranged.

When referring to FIG. 11A, the spacers 22-151 to 22-156 are arranged in the vicinity of the sub-pixel G, respectively. From such an arrangement, each spacer 22 is caused to generate a random number in the vertical direction, and arranging positions of the spacers 22 are deviated according to the generated value.

When a random number of 0.5 is generated with respect to the spacer 22-151, the spacer 22-151 is arranged at a position which is moved in the lower side by 0.5. The position is a position of the spacer 22-171 which is illustrated in FIG. 11B. In addition, here, descriptions will be continued by setting the lower direction in the figure in the vertical direction as plus, and the upper direction as minus.

Similarly, when a random number of −0.3 is generated with respect to the spacer 22-152, the spacer 22-152 is arranged at a position which is moved upward by 0.3. The position is a position of the spacer 22-172 which is illustrated in FIG. 11B. In this manner, other spacers 22 are also arranged at positions which are deviated by the generated random number from a reference position which is denoted in FIG. 11A.

As described in below, the generated random number may be set as values in a predetermined range, or values out of the predetermined range. For example, values such as ±1.5, ±3.0, ±4.5, and ±6.0 are set as the values in a range, or out of the range. The reason for exemplifying a multiple of 1.5 is as follows.

For example, when referring to FIG. 11A, the sub-pixel G of the sub-pixel 1-5 is present at the lower side of the sub-pixel G of the sub-pixel 1-2 by 3a. Accordingly, when assuming that 3 is generated as a random number, the spacer 22 is moved from the sub-pixel G to the sub-pixel G, thereby moving to the sub-pixel of the same color. Accordingly, when the random number is 3 or less, it is possible to prevent such a matter from occurring.

In addition, a case can be considered in which −1.5 is generated as a random number with respect to the spacer 22 which is arranged at the sub-pixel G by assuming that the spacer 22 is also present at the sub-pixel G of the sub-pixel 1-5 as a reference position. In addition, it is assumed that 1.5 is generated as a random number with respect to the spacer 22 which is present at a position of the sub-pixel G of the sub-pixel 1-2. In this case, the spacer 22 is arranged at a position which is moved downward by 1.5a from the sub-pixel G of the sub-pixel 1-2, and is arranged at a position which is moved upward by 1.5a from the sub-pixel G of the sub-pixel 1-5, as well.

In this case, two spacers 22 are arranged at a middle position of the sub-pixel 1-2 and the sub-pixel 1-5. It is preferable that 1.5 be excluded as the random number in order to prevent such an occurrence. Accordingly, when the random number is a value within 1.5, such a matter does not happen.

In addition, even when the random number is 1.5 or more, it is possible to prevent the spacer 22 from being arranged at the same position, accordingly, the random number may be 1.5 or more. When the random number is 1.5 or less, or 3.0 or less, the spacer 22 is deviated to a position which is close from the reference position, and is arranged. In addition, when a random number is 3.0 or more, the spacer 22 is arranged by being deviated to a position which is separated by one pixel or more.

Accordingly, when a relatively lot of spacers 22 are arranged, for example, in order to obtain an intensity, it is possible to adjust the number of spacers 22 by setting a value which is generated as a random number to be small, and the number of positions of the spacer 22 as a reference to be large. In addition, when a relatively small number of spacers 22 are arranged in order to reduce influence by the spacer 22, it is possible to adjust the number of spacers 22 by setting a value which is generated as a random number to be large, and the number of positions of the spacer 22 as a reference to be small.

The number of spacers 22 can be adjusted by controlling the number of positions of the spacers 22 as the reference, and the range of the generated random number.

In addition, here, it has been described assuming that the size of the sub-pixel is the same in any color, and the length in the vertical direction is “a”, however, there is a case in which the size of the sub-pixel is designed to be different depending on color. There is a case in which the sizes of the sub-pixels are different, respectively, for example, the size of the sub-pixel R is a, the size of the sub-pixel G is b, and the size of the sub-pixel B is c.

When the sub-pixels have different shapes in this manner, it is preferable to set a random number to a value of one pixel or more. Since the length of one pixel is (a+b+c), by causing a value greater than the value to be generated as the random value, it is possible to prevent the spacer 22 from being arranged in the vicinity of the sub-pixel of the same color, similarly to the above described case.

In addition, here, as illustrated in FIG. 11A, the position of the sub-pixel G has been described as a reference arranging position of the spacer 22, however, as a matter of course, the sub-pixel R, or the sub-pixel B may be set as the reference position. In addition, for example, as illustrated in FIG. 8, the respective position of the sub-pixels R, G, and B may be set as the reference position. In this case, since the reference position itself is distributed to RGB, the random number may be a value such as ±a.

In addition, it is preferable to set a reference position to one at a row, for example, to set only a start position, and determine the arranging position of the spacer 22 using a random number which is sequentially generated from the start position. That is, it is preferable to determine the arranging position according to the sequentially generated random number, for example, the arranging position of the spacer 22 which is arranged next to the start position is determined by the generated random number, and the arranging position of the spacer 22 which is arranged next to the determined arranging position is determined by the generated random number.

### Regarding Arrangement of Seventh Spacer

Subsequently, the arranging position of the spacer 22 when using the liquid crystal lens panel 11 will be described. In addition, in the above description, the example in which the spacer 22 is arranged on a position corresponding to the black matrix of the LCD 13 has been described, however, the spacer 22 is not limited to being arranged on the black matrix.

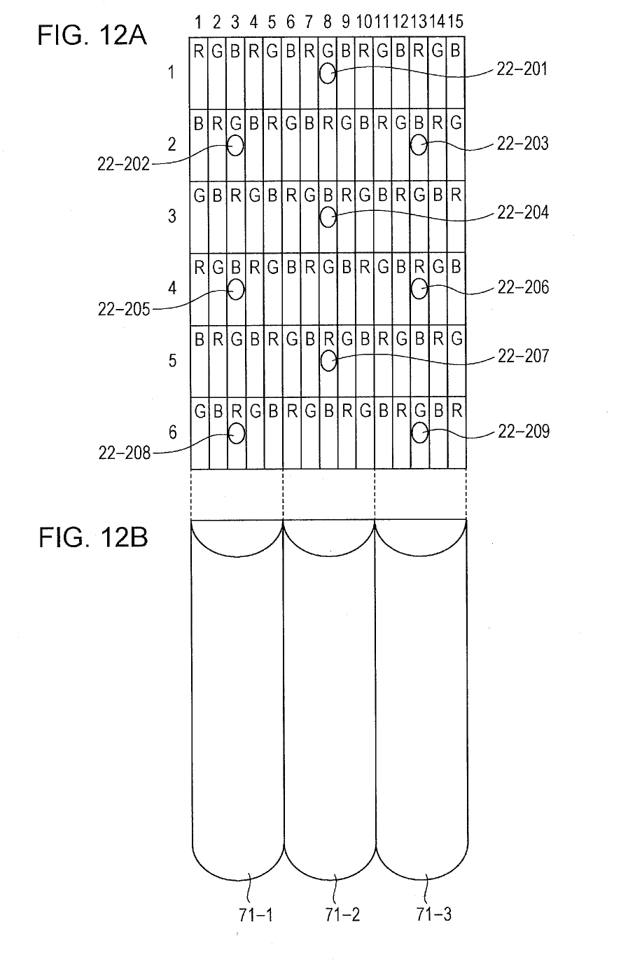

An example in which the spacer 22 is arranged on the pixels, not on the black matrix is illustrated in FIG. 12A. The pixel arrangement illustrated in FIG. 12A is an example in which one pixel is configured by three sub-pixels. That is, as illustrated in FIG. 12A, for example, one pixel is configured by three sub-pixels of the sub-pixel R of the sub-pixel 1-1, the sub-pixel G of the sub-pixel 2-1, and the sub-pixel B of the sub-pixel 3-1. In addition, the sub-pixels illustrated in FIG. 12A are arranged with three sub-pixels so that the same color is arranged in the obliquely upward direction.

The spacer 22-201 of the liquid crystal lens panel 11 is located on the sub-pixel G of the sub-pixel 1-8. The spacer 22-202 is located on the sub-pixel G of the sub-pixel 3-2. The spacer 22-203 is located on the sub-pixel B of the sub-pixel 13-2. The spacer 22-204 is located on the sub-pixel B of the sub-pixel 8-3.

The spacer 22-205 is located on the sub-pixel B of the sub-pixel 3-4. The spacer 22-206 is located on the sub-pixel R of the sub-pixel 13-4. The spacer 22-207 is located on the sub-pixel R of the sub-pixel 8-5. The spacer 22-208 is located on the sub-pixel R of the sub-pixel 3-6. The spacer 22-209 is located on the sub-pixel G of the sub-pixel 13-26.

For example, the spacers 22-202, 22-205, and 22-206 which are arranged in the vertical direction are respectively arranged on the sub-pixels G, B, and R in this order. In this manner, the sub-pixels in which the spacer 22 supplied to one predetermined viewpoint is arranged are sub-pixels of different color. In this manner, the spacer 22 is provided in the sub-pixels of different color. Accordingly, it is possible to prevent the irregular color of the rainbow shape.

In addition, in the example illustrated in FIG. 12A, the spacers 22-201 to 22-209 are regularly arranged, not randomly. Accordingly, it is possible to prevent the deterioration in the image quality such as the crosstalk which occurs when the spacer 22 is localized.

In addition, as illustrated in FIG. 12B, by arranging the lens of the liquid crystal lens panel 11, it is possible to suppress the deterioration in the optical property. A part of the lens of the liquid crystal lens panel 11 is illustrated in FIG. 12B. The spacers 22-201 to 22-209 are arranged at the respective center portion of the lenses 71-1 to 71-3. In this manner, by arranging the spacer 22 at the center portion of the lens 71, it is possible to suppress the deterioration of the optical property of the liquid crystal lens panel 11.

### Regarding Arrangement of Eighth Spacer

In the above described embodiment, a case has been exemplified in which the position of the spacer 22 is changed to a suitable position without changing the position of the sub-pixel. Subsequently, a case will be exemplified in which the arrangement of the sub-pixel is changed without changing the position of the spacer 22. In this case, it is possible to correspond by changing the arrangement of the pixels of the LCD 13 using the liquid crystal lens panel 11 as is.

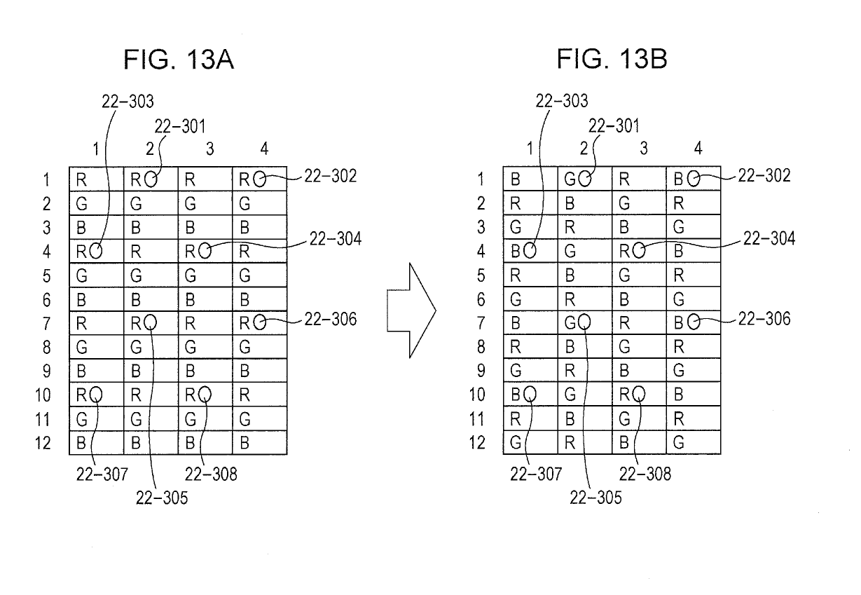

FIG. 13A is a diagram which describes the arrangement of the sub-pixel before changing the arrangement of the sub-pixel, and the arrangement of the spacer 22. FIG. 13A is an example in which one pixel is configured by three sub-pixels, and three sub-pixels configuring one pixel are arranged in the vertical direction. That is, in the arrangement of pixels illustrated in FIG. 13A, the sub-pixels 1-1 to 4-1 are set to the sub-pixel R, the sub-pixels 1-2 to 4-2 which are the second from the top are set to the sub-pixel G, and the sub-pixels 1-3 to 4-3 which are the third from the top are set to the sub-pixel B. In the vertical direction, the sub-pixels R, G, and B are repeatedly arranged.

The spacers 22-301 to 22-308 are respectively arranged at positions of the sub-pixel R. The spacer 22-301 is arranged at a position of the sub-pixel R of the sub-pixel 2-1, the spacer 22-302 is arranged at a position of the sub-pixel R of the sub-pixel 4-1. In addition, the spacer 22-303 is arranged at a position of the sub-pixel R of the sub-pixel 1-4, and the spacer 22-304 is arranged at a position of the sub-pixel R of the sub-pixel 3-4.

The spacer 22-305 is arranged at a position of the sub-pixel R of the sub-pixel 2-7, the spacer 22-306 is arranged at a position of the sub-pixel R of the sub-pixel 4-7. In addition, the spacer 22-307 is arranged at a position of the sub-pixel R of the sub-pixel 1-10, and the spacer 22-308 is arranged at a position of the sub-pixel R of the sub-pixel 3-10.

In this manner, when the spacer 22 of the liquid crystal lens panel 11 is arranged at positions of the same color, only at the positions of the red sub-pixel R in this case, there is a possibility that the irregular color of the rainbow shape occurs. Therefore, the spacer 22 is distributed to RGB by arranging the sub-pixels as illustrated in FIG. 13B, without changing the position of the spacer 22 of the liquid crystal lens panel 11.

When referring to FIG. 13B, the sub-pixels are configured by repeating the sub-pixels R, G, and B in both the vertical and horizontal directions. For example, R, G, and B are repeated in the horizontal direction such as the sub-pixel B of the sub-pixel 1-1, the sub-pixel G of the sub-pixel 2-1 which is close thereto in the horizontal direction, and the sub-pixel R of the sub-pixel 3-1 which is closer thereto.

In addition, for example, R, G, and B are repeated in the vertical direction such as the sub-pixel B of the sub-pixel 1-1, the sub-pixel R of the sub-pixel 1-2 which is close thereto in the vertical direction, and the sub-pixel G of the sub-pixel 1-3 which is closer thereto.

According to such an arrangement, the sub-pixels of the same color are linearly arranged in the obliquely downward direction to the right. That is, for example, when focusing on the sub-pixel B, the sub-pixels B are linearly arranged in the obliquely downward direction such as the sub-pixel 1-1, the sub-pixel 2-2, the sub-pixel 3-3, and the sub-pixel 4-4. Similarly, the sub-pixels of other color are linearly arranged in the obliquely downward direction to the right.

By arranging in this manner, the spacers 22 are arranged by being distributed to RGB. The spacer 22-301 is located on the sub-pixel G, the spacer 22-302 is located on the sub-pixel B, the spacer 22-303 is located on the sub-pixel B, and the spacer 22-304 is located on the sub-pixel R.

In addition, the spacer 22-305 is located on the sub-pixel G, the spacer 22-306 is located on the sub-pixel B, the spacer 22-307 is located on the sub-pixel B, and the spacer 22-308 is located on the sub-pixel R.

In this manner, the spacers 22 are respectively arranged on the sub-pixels R, G, and B. Accordingly, it is possible to prevent the irregular color of the rainbow shape. In addition, in the example illustrated in FIG. 13B, the spacers 22-301 to 22-308 are regularly arranged, not randomly. Accordingly, it is possible to prevent the deterioration in the image quality such as the crosstalk which occurs when the spacer 22 is localized.

### Regarding Applying of Display Device

The above described LCD 13, or the liquid crystal lens panel 11 which is laminated on the LCD 13, or the parallax barrier 101 has the shape of a flat panel, and can be applied to various electronic devices, for example, a digital camera, a notebook-type personal computer, a mobile phone, a video camera, or the like. It is possible to apply the present technology to displays of electronic devices of all types on which a driving signal which is input to the electronic devices, or is generated in the electronic devices can be displayed as an image, or a video. Hereinafter, an example of an electronic device to which such a display device is applied will be described. The electronic device includes a main body which basically processes information, and a display which displays information which is input to the main body, or information output from the main body.

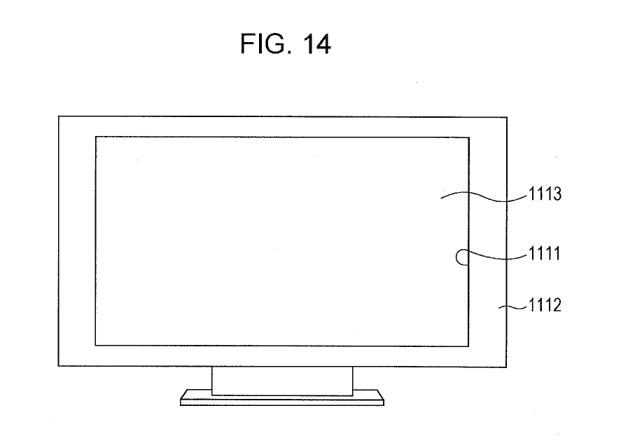

FIG. 14 illustrates a television receiver to which the present technology is applied, the television receiver includes an image display screen 1111 which is configured by a front panel 1112, a filter glass 1113, or the like, and is manufactured using the display device of the present technology in the image display screen 1111. By using the image display screen 1111 which is configured by the LCD 13, or the liquid crystal lens panel 11 which is laminated on the LCD 13, or the parallax barrier 101, for example, a three-dimensional image is provided to a user.

In addition, the present technology can also be applied to the note type personal computer. In a main body of the note type personal computer, a keyboard which is operated when inputting characters or the like is included, a display unit which displays an image is included in a main body cover, and the notebook-type personal computer is manufactured by using the display device of the present technology in the display unit. By the display unit which is configured by the LCD 13, the liquid crystal lens panel 11 which is laminated on the LCD 13, or the parallax barrier 101, for example, the three-dimensional image is provided to a user.

In addition, the present technology can also be applied to a mobile terminal device. The mobile terminal device includes an upper housing, a lower housing, a connection unit (for example, hinge portion), a display, a sub-display, picture light, a camera, or the like. By using the display device of the present technology in the display, or the sub-display, the mobile terminal device is manufactured. By the display, or the sub-display which is configured by the LCD 13, the liquid crystal lens panel 11 which is laminated on the LCD 13, or the parallax barrier 101, for example, the three-dimensional image is provided to a user.

In addition, the present technology can be applied to a video camera. The video camera includes a main body unit, a lens for photographing an object on the side which is facing forward, a start/step switch which is used when photographing, a monitor, or the like, and is manufactured using the display device of the present technology in the monitor. Using the monitor which is configured by the LCD 13, the liquid crystal lens panel 11 which is laminated on the LCD 13, or the parallax barrier 101, for example, the three-dimensional image is provided to a user.

In the above described embodiment, the LCD 13, the liquid crystal lens panel 11 which is laminated on the LCD 13, or the parallax barrier 101 has been described as an example. However, the application of the present technology is not limited to the display device which is configured by the LCD 13, the liquid crystal lens panel 11 which is laminated on the LCD 13, or the parallax barrier 101. For example, the present technology can be applied to other display devices such as an organic EL, or the like. In addition, the present technology can also be applied to a display for a multi-screen display on which a screen is seen in which a view angle is differentiated.

In addition, the embodiment of the present technology is not limited to the above described embodiment, and can be variously changed without departing from the scope of the present technology.

In addition, the present technology can also have configuration as follows.

(1) A display device which includes a display unit having a plurality of pixels, and an optical device, in which the optical device is provided with a first substrate, a second substrate, and a structure for securing a predetermined gap between the first substrate and the second substrate, the pixels are configured by a plurality of sub-pixels of which colors are different, and are aligned in a first direction, and a gap at which the structure is arranged in the first direction is different from a gap at which the pixels are arranged.

(2) The display device which is disclosed in (1) in which the structure is created at a position corresponding to a black matrix in the display unit.

(3) The display device which is disclosed in (1) or (2) in which the structure is arranged by being scattered in the vicinity of the sub-pixels of different colors in at least one direction of a vertical direction and horizontal direction.

(4) The display device which is disclosed in (1) or (2) in which the structure which is neighboring in the vertical direction, or the horizontal direction is arranged by being deviated in the neighboring direction.

(5) The display device which is disclosed in (1) or (2) in which the structure which is neighboring in the vertical direction, or the horizontal direction is arranged at a position which is separated by a predetermined number of sub-pixels in the neighboring direction.

(6) The display device which is disclosed in (1) or (2) in which the structure which is neighboring in the vertical direction, or the horizontal direction is arranged at a position which is separated by a predetermined multiple based on a gap between the pixels in the neighboring direction.

(7) The display device which is disclosed in (1) or (2) in which the structure which is neighboring in the vertical direction, or the horizontal direction is arranged at a position which is separated by a generated random number based on the gap between the pixels in the neighboring direction.

(8) The display device which is disclosed in any one of (1) to (7) in which the structure is arranged at a center portion of a lens unit which selectively changes a passage state of rays from the display unit.

(9) The display device which is disclosed in (1) in which the sub-pixel is arranged so that a position at which the neighboring structure is arranged becomes a sub-pixel of different color.

(10) An electronic device which includes a display unit having a plurality of pixels, and an optical device, in which the optical device is provided with a first substrate, a second substrate, and a structure for securing a predetermined gap between the first substrate and the second substrate, the pixels are configured by a plurality of sub-pixels of which colors are different, and are aligned in a first direction, and a gap at which the structure is arranged in the first direction is different from a gap at which the pixels are arranged.

The present disclosure contains subject matter related to that disclosed in Japanese Priority Patent Application JP 2012-067938 filed in the Japan Patent Office on Mar. 23, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a display unit having a plurality of pixels; and
an optical device,
wherein the optical device is provided with a first substrate, a second substrate, and a structure for securing a predetermined gap between the first substrate and the second substrate,
wherein the pixels are configured by a plurality of sub-pixels of which colors are different, and are aligned in a first direction, and
wherein a gap at which the structure is arranged in the first direction is different from a gap at which the pixels are arranged.

2. The display device according to claim 1,
wherein the structure is created at a position corresponding to a black matrix in the display unit.

3. The display device according to claim 1,
wherein the structure is arranged by being scattered in the vicinity of the sub-pixels of different colors in at least one direction of a vertical direction and a horizontal direction.

4. The display device according to claim 1,
wherein the structure which is neighboring in the vertical direction, or the horizontal direction is arranged by being deviated in the neighboring direction.

5. The display device according to claim 1,
wherein the structure which is neighboring in the vertical direction, or the horizontal direction is arranged at a position which is separated by a predetermined number of sub-pixels in the neighboring direction.

6. The display device according to claim 1,
wherein the structure which is neighboring in the vertical direction, or the horizontal direction is arranged at a position which is separated by a predetermined multiple based on a gap between the pixels in the neighboring direction.

7. The display device according to claim 1,
wherein the structure which is neighboring in the vertical direction, or the horizontal direction is arranged at a position which is separated by a generated random number based on the gap between the pixels in the neighboring direction.

8. The display device according to claim 1,
wherein the structure is arranged at a center portion of a lens unit which selectively changes a passage state of rays from the display unit.

9. The display device according to claim 1,
wherein the sub-pixel is arranged so that a position where the neighboring structure is arranged becomes a sub-pixel of different color.

10. An electronic device comprising:
a display unit having a plurality of pixels; and
an optical device;
wherein the optical device is provided with a first substrate, a second substrate, and a structure for securing a predetermined gap between the first substrate and the second substrate,
wherein the pixels are configured by a plurality of sub-pixels of which colors are different, and are aligned in a first direction, and
wherein a gap at which the structure is arranged in the first direction is different from a gap at which the pixels are arranged.
